(19) United States
(12) Patent Application Publication
(10) Pub. No.: US 2025/0192974 A1
(43) Pub. Date: Jun. 12, 2025

(54) CLOCK DISTRIBUTION USING RESONANT TRANSMISSION LINE

(71) Applicant: Intel Corporation, Santa Clara, CA (US)

(72) Inventors: Susnata Mondal, Hillsboro, OR (US); Mozhgan Mansuri, Portland, OR (US)

(21) Appl. No.: 18/534,465

(22) Filed: Dec. 8, 2023

(51) Int. Cl. H04L 7/00

(52) U.S. Cl. CPC H04L 7/0008

(57) ABSTRACT

Embodiments herein relate to a clock distribution network. In one aspect, the network includes a resonant transmission line-based architecture which includes a single inductive-capacitance (LC) termination along the distribution and an additional capacitive termination at the end of the distribution to independently tune the primary and secondary resonance frequencies of the network and perform 3rd-harmonic filtering. The LC termination can include a coil inductor or a short-circuited termination line with parallel conductors to provide an inductance.

### FIELD

The present application generally relates to the field of clock distribution networks.

### BACKGROUND

A clock distribution network includes transmission lines, such as metal traces and vias, for distributing a clock signal to different components of an integrated circuit or chip, for instance. The clock signal can be used to synchronize the operations of different circuits on the chip, such as for transmitting and receiving data. However, various challenges are presented in providing an efficient clock distribution network.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts an example clock distribution network 100 which includes a non-resonant transmission line 110 with a resistive termination 120 at an output end 112 of the transmission line, in accordance with various embodiments.

FIG. 2 depicts an example clock distribution network 200 which includes a resonant transmission line 110 with double inductive-capacitive (LC) terminations 210 and 220 at input and output ends 111 and 112, respectively, of the transmission line, in accordance with various embodiments.

FIG. 3 depicts an example clock distribution network 300 which includes a resonant transmission line 310 with a single LC termination 330 which is partway along a length of the transmission line and LC harmonic filtering 320 at an input end 341 of the transmission line, in accordance with various embodiments.

FIG. 4 depicts an example clock distribution network 400 which includes a resonant transmission line 410 with a single LC termination 420 which is partway along a length of the transmission line and a capacitive termination 430 at an output end 442 of the transmission line to provide capacitive harmonic tuning, in accordance with various embodiments.

FIG. 5 depicts another example clock distribution network 500 which includes a resonant transmission line 510 with a single LC termination 520 which is partway along a length of the transmission line, where an inductance is provided by a short-circuited transmission line 540, and a capacitive termination 530 at an output end of the transmission line to provide capacitive harmonic tuning, in accordance with various embodiments.

FIG. 6 depicts plots of amplitude in decibels (dB) versus frequency in GHz for the clock distribution network of FIG. 4, for different tuned values of C₁, in accordance with various embodiments.

FIG. 7 depicts plots of amplitude in decibels (dB) versus frequency in GHz for the clock distribution network of FIG. 4, for different tuned values of C₁ and C₂, in accordance with various embodiments.

FIG. 8 depicts plots of a first-to-third harmonic ratio in dB versus frequency in GHz for the clock distribution network of FIG. 4, with tuning of C₁ and C₂ (plot 800) and tuning of C1 only (plot 810), in accordance with various embodiments.

FIG. 9 depicts a plot of voltage versus time representing a transient response of the clock distribution network of FIG. 4 with an operational frequency of 10 GHz, in accordance with various embodiments.

FIG. 10 depicts a plot of voltage versus time representing a transient response of the clock distribution network of FIG. 4 with an operational frequency of 16 GHz, in accordance with various embodiments.

FIG. 11A depicts an example two-sided clock distribution network 1100 consistent with FIGS. 4 and 5, in accordance with various embodiments.

FIG. 11B depicts example implementations of an impedance block 1150 consistent with FIG. 11A as one or more coiled inductors 1180 or as an inductive short-circuited transmission line 1190, in accordance with various embodiments.

FIG. 12 depicts an example four-sided clock distribution network 1200 consistent with FIGS. 4 and 5, in accordance with various embodiments.

FIG. 13 depicts plots of amplitude in decibels (dB) versus frequency in GHz for a one-sided distribution consistent with FIG. 4 (plot 1300), a two-sided distribution consistent with FIG. 11A (plot 1310), and a four-sided distribution consistent with FIG. 12 (plot 1320), where the inductance of the LC termination is provided by the coiled inductors 1180 of FIG. 11B, in accordance with various embodiments.

FIG. 14 depicts plots of amplitude in decibels (dB) versus frequency in GHz for a one-sided distribution consistent with FIG. 5 (plot 1400), a two-sided distribution consistent with FIG. 11A (plot 1410), and a four-sided distribution consistent with FIG. 12 (plot 1420), where the inductance of the LC termination is provided by the inductive short-circuited transmission line 1190 of FIG. 11B, in accordance with various embodiments.

FIG. 15 illustrates an example of components that may be present in a computing system 1550 for implementing the techniques (e.g., operations, processes, methods, and methodologies) described herein.

### DETAILED DESCRIPTION

As mentioned at the outset, various challenges are presented in providing an efficient clock distribution network.

There is a continuing demand for aggressive data-rate scaling in clock distribution networks including those used in optical, wireline and wireless systems. Example of optical systems include those using silicon photonics and Vertical Cavity Surface-Emitting Laser (VCSEL)-based discrete photonics. Examples of wireline systems include those using a Serializer/Deserializer (SerDes), Peripheral Component Interconnect Express (PCIe), Universal Chiplet Interconnect Express (UCIe), etc. Examples of wireless systems include millimeter-wave cellular and Wi-Fi systems.

This scaling requires higher operating clock or local oscillator (LO) frequencies. A compact, low-power, low-jitter, long-range clock distribution architecture is vital for improving the system's energy efficiency, where a significant fraction of system power is usually spent on clocking. Non-resonant and resonant transmission line (TL)-based long-range clock distribution architectures are subject to tradeoffs in terms of area efficiency, energy efficiency and jitter performance.

One possible solution is to provide clock distribution using inverter-based repeaters. However, these types of repeaters suffer from jitter accumulation, supply-induced jitter generation, and high power consumption, especially as the clock frequency and distribution length continue to scale.

Another possible solution is to use a resistively terminated transmission line (TL). A resistive terminated non-resonant TL distribution can achieve low power and low jitter compared to inverter-based repeaters, especially as the distribution length approaches a fraction of the wavelength, λ. However, this solution still consumes high power due to a relatively low termination impedance and additional jitter from local level converting buffers or level shifters.

Another possible solution is a resonant TL with a double inductive-capacitive (LC) termination. The energy efficiency and jitter performance of the resistive-terminated TL can be improved by using resonant TLs. For example, the energy efficiency can be improved by greater than 4×. However, the resonant TL distribution with double-side LC-termination requires two inductors and hence has poor area efficiency. Moreover, as the 3rd-harmonic gain is not controlled, this architecture can cause significant distortion from the unwanted 3rd-harmonic content.

Another possible solution is a resonant TL with a single LC termination and harmonic filtering. This can improve inductor area by 2× and perform 3rd-harmonic distortion filtering. However, it still requires two inductors in the clock distribution network.

The solutions provided herein address the above and other disadvantages. In one aspect, low power, low jitter, and low distortion resonant-TL-based clock distribution architectures are provided that improve area efficiency by reducing the number of required inductors in the distribution.

In one aspect, a resonant-TL-based clock distribution architecture is provided which includes a single LC termination (along the distribution) and an additional capacitive termination (at the end of the distribution) to independently tune the primary and secondary resonance frequencies of the distribution network and perform 3rd-harmonic filtering. The proposed solution improves inductor area by 2× and the worst-case 3rd-harmonic distortion by >10 dB compared to a similar design without the capacitive harmonic tuning, while also maintaining the power and jitter filtering benefits of a resonant TL.

In another aspect, a TL-based resonant termination is provided that further improves inductor area overhead by avoiding the need for a traditional coil inductor.

The solutions provide a number of advantages. For example, as the link data rate continues to increase, resonant clocking can meet the jitter and power targets, especially in high-speed SerDes, e.g., Digital-to-Analog (DAC)-based Pulse Amplitude Modulation with Four Levels (PAM4), coherent wireless systems, e.g., sub-6 GHz or millimeter-wave cellular/WiFi, wireline systems, e.g., PCIe, UCIe, etc. and optical systems, e.g., silicon photonics and VCSEL-based-discrete photonics systems.

The solutions improve area efficiency and coupling between inductors, which has been an impediment to wide scale adoption of resonant clocking with multiple inductors, by reducing inductor area by over 2×. The solutions can be used in next-generation silicon photonics (SiPh) transceivers, optical compute interconnects (OCIs), and SerDes products, for example.

These and other features will be further apparent in view of the following discussion.

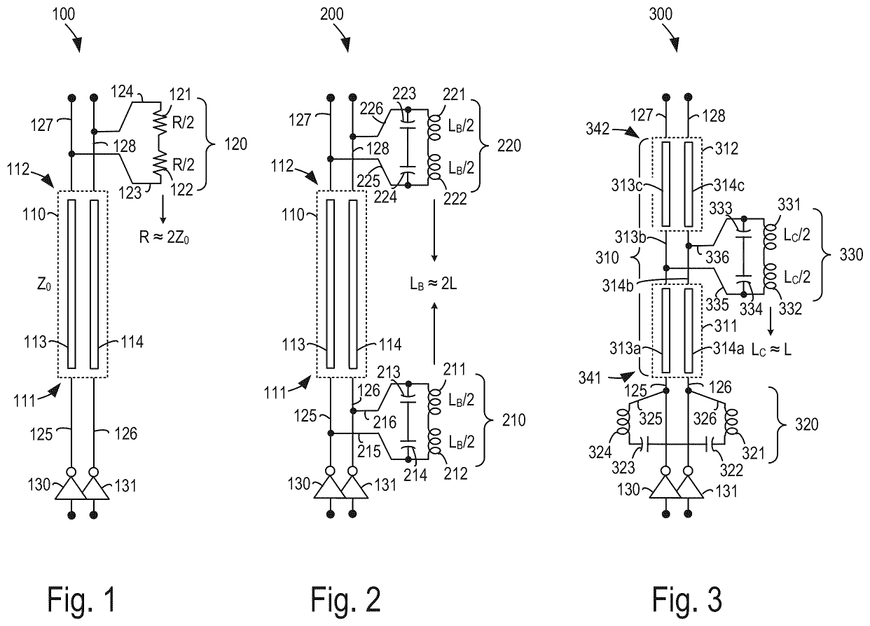

FIGS. 1-5 depicts example clock distribution architectures that can be used to distribute a clock from a clock generation node (e.g., a phase-locked loop, PLL, or LO) to a physically distant node, e.g., within a chip or between chips.

FIG. 1 depicts an example clock distribution network 100 which includes a non-resonant transmission line 110 with a resistive termination 120 at an output end 112 of the transmission line, in accordance with various embodiments. The clock distribution network 100 includes a first clock driver 130 and a second clock driver 131. The first and second clock drivers (a clock source) can output first and second clock signals, respectively, where the first clock signal is an inverse of the second clock signal. The first clock signal is applied to a first signal line 113 (or conductor) of the TL via a first TL input path 125, and the second clock signal is applied to a second signal line 114 (or conductor) of the TL via a second TL input path 126, at an input end 111 of the TL. The TL has an impedance Z₀. The resistive termination 120 includes resistors 121 and 122 coupled in series. Each resistor may have a same resistance of R/2, so the combined resistance is R, which may be approximately equal to 2Z₀. The resistors are coupled to the first and second TL output paths 127 and 128, respectively, via branch paths 123 and 124, respectively.

This resistive terminated TL-based non-resonant distribution has advantages including low area requirement due to the absence of an inductor and low distortion. Disadvantages include high power consumption and no jitter filtering.

FIG. 2 depicts an example clock distribution network 200 which includes a resonant transmission line 110 with double inductive-capacitive (LC) terminations 210 and 220 at input and output ends 111 and 112, respectively, of the transmission line, in accordance with various embodiments. The LC termination 210 at the input end 111 includes inductors 211 and 212 in series which each have an inductance of L_{B}/2, for example, for a total inductance of L_{B}. The LC termination 210 also includes capacitors 213 and 214 in series. In the termination 210, the inductors and capacitors are coupled to the first and second TL input paths 125 and 126, respectively, via branch paths 215 and 216, respectively. In the termination 220, the inductors and capacitors are coupled to the first and second TL output paths 127 and 128, respectively, via branch paths 225 and 226, respectively. The capacitance of each termination can be determined based on the formula Ca*Cb/(Ca+Cb) for two capacitors Ca and Cb in series. In each termination, the capacitors are in parallel with the inductors.

The LC termination 220 at the output end 112 includes inductors 221 and 222 in series which each have an inductance of L_{B}/2, for example, for a total inductance of L_{B}. The LC termination 220 also includes capacitors 223 and 224 in series. The capacitors are in parallel with the inductors. The inductors and capacitors are coupled to the first signal line 113 via a branch path 225 and the first output path 127 and to the second signal line 114 via a branch path 226 and the second output path 128.

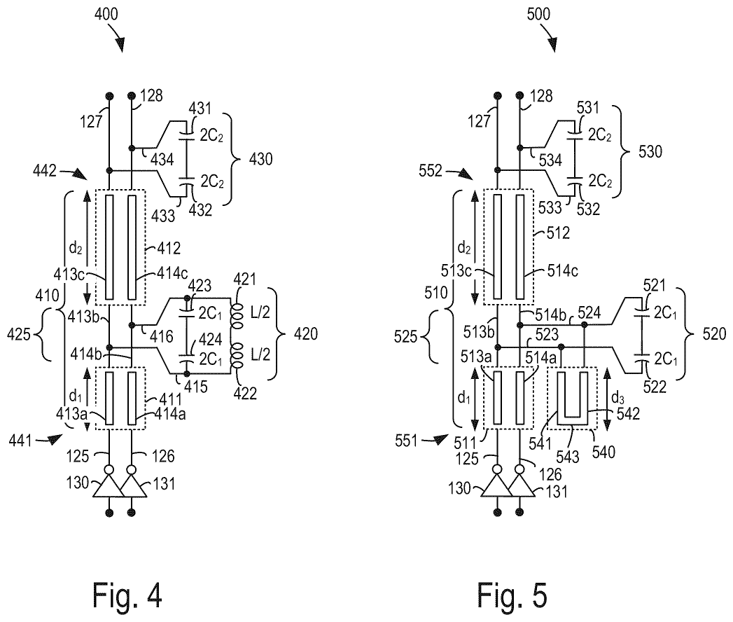

Also, L_{B}˜2L, where L is referenced in FIG. 4.

The inductors can be coil or spiral shaped for example.

This approach has advantages including low power consumption and jitter filtering.

The jitter filtering results from the use of one or more inductors. Disadvantages include the area required for two inductors at each termination and the presence of third harmonic distortion.

FIG. 3 depicts an example clock distribution network 300 which includes a resonant transmission line 310 with a single LC termination 330 which is partway along a length of the transmission line and LC harmonic filtering 320 at an input end 341 of the transmission line, in accordance with various embodiments. The transmission line 310 includes a first portion 311 with first and second signal line portions 313a and 314a, respectively, an intermediate portion with first and second signal line portions 313b and 314b, respectively, and a second portion 312 with first and second signal line portions 313c and 314c, respectively. At the output end 342 of the TL, the first and second signal line portions 313c and 314c are coupled to the output paths 127 and 128, respectively. At the input end 341 of the TL, the first and second signal line portions 313a and 314a are coupled to the input paths 125 and 126, respectively.

The LC termination 320 at the input end 111 includes, in series, an inductor 321, capacitors 322 and 323 and an inductor 324. The inductors and capacitors are coupled to the first and second TL input paths 125 and 126, respectively, via branch paths 325 and 326, respectively.

The LC termination 330 which is partway along the length of the TL includes inductors 331 and 332 in series which each have an inductance of L_{C}/2, for example, for a total inductance of L_{C}. The LC termination 330 also includes capacitors 333 and 334 in series with each other and in parallel with the inductors. The inductors and capacitors are coupled to the first and second signal line portions 313b and 314b, respectively, via branch paths 335 and 336, respectively.

This approach has advantages including low power consumption, jitter filtering and a harmonic filter for low distortion. Disadvantages include the area required for the inductors in the termination 320 and the harmonic filter of the LC termination 330.

Also, L_{C}≈L, where L is depicted in FIG. 4.

FIG. 4 depicts an example clock distribution network 400 which includes a resonant transmission line 410 with a single LC termination 420 which is partway along a length of the transmission line and a capacitive termination 430 at an output end 442 of the transmission line to provide capacitive harmonic tuning, in accordance with various embodiments.

The transmission line 410 includes a first portion 411 with first and second signal line portions 413a and 414a, respectively, and with a length d1, an intermediate portion 425 with first and second signal line portions 413b and 414b, respectively, and a second portion 412 with first and second signal line portions 413c and 414c, respectively, and with a length d2. At the output end 442 of the TL, the first and second signal line portions 413c and 414c are coupled to the output paths 127 and 128, respectively. The intermediate portion may have a negligible length compared to d1 and d2 and is shown in an expanded way for clarity. At the input end 441 of the TL, the first and second signal line portions 413a and 414a are coupled to the input paths 125 and 126, respectively.

The LC termination 420 which is partway along the length of the TL includes one or more inductors, such as inductors 421 and 422 in series which each have an inductance of L/2, for example, for a total inductance of L. The LC termination 420 also includes one or more capacitors, such as capacitors 423 and 424, each having a capacitance 2C₁, in series with each other and in parallel with the inductors. The inductors and capacitors are coupled to the first and second signal line portions 413b and 414b, respectively, via branch paths 415 and 416, respectively. The capacitive termination 430 at the output end 442 includes one or more capacitors, such as capacitors 431 and 432 in series, each having a capacitance of 2C₂. The capacitors are coupled to the first and second TL output paths 127 and 128, respectively, via branch paths 433 and 434, respectively. This approach has advantages including low power consumption, jitter filtering, low area due to the use of only one inductor (made up of inductors 421 and 422) and a harmonic tuning for low distortion. In particular, the capacitive termination 430 can include adjustable capacitors for tuning a third harmonic of the signals on the TL.

The inductors 421 and 422 may be coil or spiral shaped, for example.

The combined capacitance of the capacitors 423 and 424 is C₁ and the combined capacitance of the capacitors 431 and 432 is C₂.

An adjustable capacitor can be formed by a set of capacitors of different capacitances in parallel and coupled to respective switches, where one of the capacitors with the desired capacitance can be switched in by a making one of the switches conductive. A digital code/control signal can be provided by a control circuit on a bus to select one of the capacitors. In another approach, combinations of multiple capacitors can be switched in to provide a desired capacitance.

In an example design, d₂≈2d₁, or at least d₂>d₁, C₁≈4C₂, d1+d2=1.5 mm (total distribution length), C₁=75 fF−375 fF and L=400 pH (inductive termination).

This approach has advantages including low power consumption, jitter filtering, reduced area due to one inductor instead of two, and the capability for harmonic tuning due to the adjustable capacitors for low distortion.

The single LC termination 420 is at a tap point (intermediate portion 425) along the TL where the distance from the source node (d₁) is less than the distance from the destination node (d₂), e.g., d₁<d₂. This design also employs another tunable capacitor bank due to the capacitive termination 430 at the destination node to tune the 3rd-harmonic signal amplitude. If C₂ is selected to be relatively smaller than C₁, e.g., C₂≤C₁/4, the primary resonance frequency of the entire network mainly depends on C₁ and can be extracted by solving [tan(2πd₁/2)+tan(2πd₂/2)+2πfC₁Z₀]=Z₀/2πfL, where Z₀ is impedance of the TL, f is frequency and L is the length. Moreover, the secondary resonance peak of the amplitude response can be tuned by tuning C₂. Due to this relatively independent tuning mechanism of the primary and secondary resonance frequencies, the secondary resonance frequency can be parked (set at a fixed level) to realize low gain at the 3rd-harmonic of the fundamental clock frequency, thereby ensuring low 3rd-harmonic distortion. As a design example, if d₂=2d1, C₁ and C₂ can be simultaneously tuned with a ratio of 4:1 to maintain low 3rd-harmonic distortion across a wide frequency of operation without the requirement of a bulky inductor-based 3rd-harmonic filter.

The terminations 420 and 430 together form a resonance tuning circuit.

FIG. 5 depicts another example clock distribution network 500 which includes a resonant transmission line 510 with a single LC termination 520 which is partway along a length of the transmission line, where an inductance is provided by a short-circuited transmission line 540 of length d3, and a capacitive termination 530 at an output end of the transmission line to provide capacitive harmonic tuning, in accordance with various embodiments.

This design is similar to that of FIG. 4 but the short-circuited transmission line 540 replaces the inductors 421 and 422.

The transmission line 510 includes a first portion 511 with first and second signal line portions 513a and 514a, respectively, and with a length d1, an intermediate portion 525 with first and second signal line portions 513b and 514b, respectively, and a second portion 512 with first and second signal line portions 513c and 514c, respectively, and with a length d2. At the output end 552 of the TL, the first and second signal line portions 513c and 514c are coupled to the output paths 127 and 128, respectively. The intermediate portion may have a negligible length compared to d1 and d2. At the input end 551 of the TL, the first and second signal line portions 513a and 514a are coupled to the input paths 125 and 126, respectively.

The LC termination 520 which is partway along the length of the TL includes one or more capacitors, such as capacitors 521 and 522 in series, each having a capacitance 2C₁. The capacitors are in parallel with the short-circuited transmission line 540, which includes first and second conductors 541 and 542, respectively, which may run parallel to one another at a constant separation distance. The first and second conductors 541 and 542 are short circuited at a path 543. This configuration results in an inductance when current passes through the first and second conductors 541 and 542 in opposite directions (antiparallel). The first and second conductors 541 and 542 run in a straight line, for instance, as linear parallel conductive paths. For reference, the mutual inductance of a pair of parallel cylindrical wires with antiparallel running current is L≈(μ₀d₃/π)(ln(s/a)+1/4), where μ₀ is permittivity of the material between the first and second conductors 541 and 542, “s” is the separation of the first and second conductors 541 and 542, and “a” is the diameter of the first and second conductors 541 and 542.

The capacitors 521 and 522 and the short-circuited transmission line 540 are coupled to the first and second signal line portions 513b and 514b, respectively, via branch paths 523 and 524, respectively.

The capacitive termination 530 at the output end 552 includes one or more capacitors, such as capacitors 531 and 532 in series, each having a capacitance of 2C₂. The capacitors are coupled to the first and second TL output paths 127 and 128, respectively, via branch paths 533 and 534, respectively.

In an example design, d2≈2d1, or at least d2>d1. Also, d3=d1 and C1≈4C2. The symbol “˜” denotes approximately equal to, e.g., within a margin of +/−5-10%.

This approach has advantages including low power consumption, jitter filtering, reduced area due to the use of a short-circuited transmission line as an inductor instead of a coil inductor, and the capability for harmonic tuning due to the adjustable capacitors for low distortion. In particular, the capacitive termination can include adjustable capacitors for tuning a third harmonic of the signals on the TL. Moreover, the short-circuited transmission line can advantageously be fabricated using the same process as for the main TL 510.

In this approach, the termination inductors 421 and 422 of FIG. 4 are replaced using a TL-based termination 540. The short-circuited TL of length d3 with a far-end short at the path 543 can provide an inductive impedance of jZ₀ tan(2πd3/2). Therefore, similar to FIG. 4, the primary resonance frequency can be extracted by solving [tan(2πd₁/2)+tan(2πd₂/2)+2πfC₁Z₀]=1/tan(2π₃/λ), where Z₀ is impedance of the TL. Moreover, similar to FIG. 4, harmonic tuning can be performed through the tunable capacitors C₂ rather than an LC 3rd-harmonic filter. Therefore, the TL 510 has one additional TL and no traditional inductor. Because of its form factor, TL-based termination is often easier to integrate with the TL-based distribution compared to a traditional inductor-based termination.

The terminations 520 and 530 together form a resonance tuning circuit.

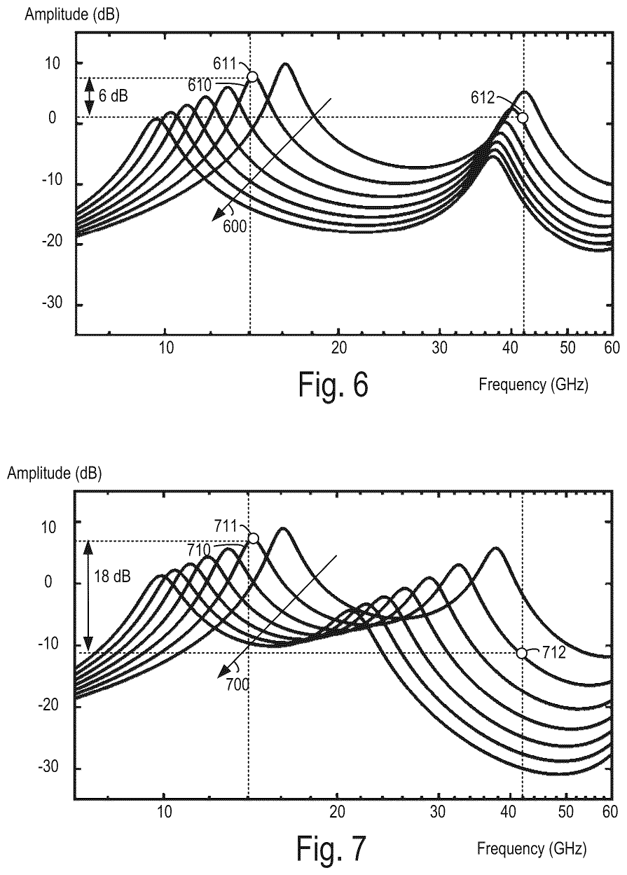

FIG. 6 depicts plots of amplitude in decibels (dB) versus frequency in GHz for the clock distribution network of FIG. 4, for different tuned values of C₁, in accordance with various embodiments. In this example, C₂ is not tuned. The arrow 600 represents increasing values of the capacitance C₁. The tuning of C₁ results in tuning of the primary resonance of the signals on the TL. For example, for the plot 610, the circle 611 denotes a peak at 14 GHz, which may be a desired clock frequency on the TL. The third harmonic would be at 42 GHZ, as represented by the circle 612. The amplitude at the third harmonic is about 6 dB lower than the primary amplitude.

FIG. 7 depicts plots of amplitude in decibels (dB) versus frequency in GHz for the clock distribution network of FIG. 4, for different tuned values of C₁ and C₂, in accordance with various embodiments. In this example, C₁ and C₂ are both tuned. The arrow 700 represents increasing values of C₁ and C₂. The tuning of C₁ and C₂ results in tuning of the primary and secondary resonances of the signals on the TL. For example, for the plot 710, the circle 711 denotes a peak at 14 GHz. The third harmonic would be at 42 GHZ, as represented by the circle 712. The amplitude at the third harmonic is about 18 dB lower than the primary amplitude. This represents a significant improvement over the example of FIG. 6. The third harmonic should be lower than the primary amplitude to reduce distortion.

FIGS. 6 and 7 depict the amplitude response of the clock distribution network with an ideal 5 mS transconductor drive. When only capacitor C₁ is tuned from 75 fF to 375 fF, only the primary resonance frequency changes from 10 GHz to 16 GHz (FIG. 6). On the other hand, if both C₁ and C₂ are tuned (with a ratio of 4:1), as in FIG. 7, both the primary and the secondary resonance frequencies change, enabling 3rd-harmonic rejection across the tuning range.

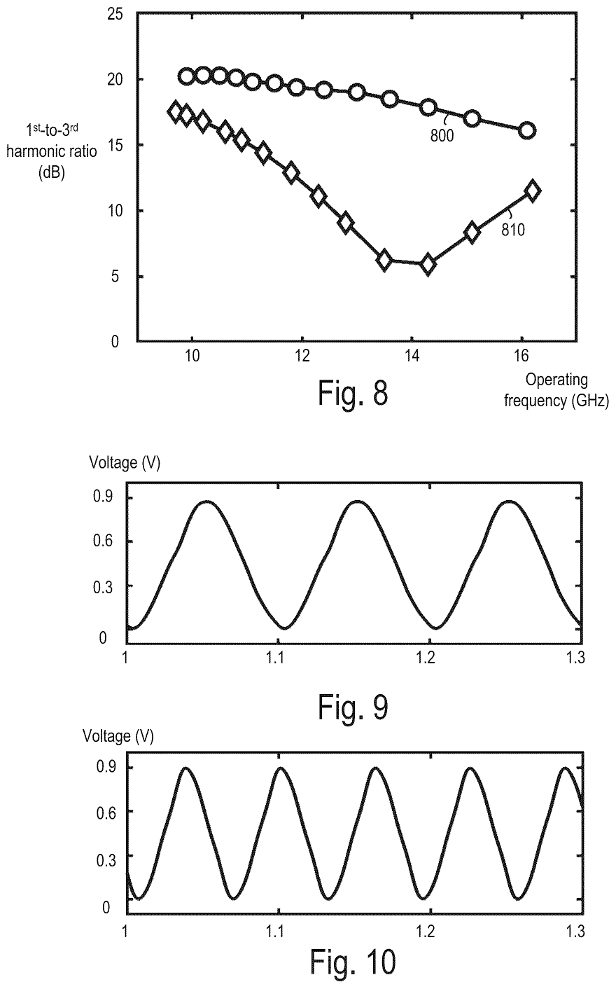

FIG. 8 depicts plots of a first-to-third harmonic ratio in dB versus frequency in GHz for the clock distribution network of FIG. 4, with tuning of C₁ and C₂ (plot 800) and tuning of C₁ only (plot 810), in accordance with various embodiments. The ratio is significantly higher for the case of tuning of both C₁ and C₂.

The ratio of 1st-to-3rd-harmonic gain is plotted in FIG. 8 across the operating frequency for only C₁ tuning and the proposed combined C₁ and C₂ tuning. As shown, >16 dB 3rd-harmonic rejection is maintained across the frequency range of interest compared to as poor as ˜6 dB worst-case rejection without the proposed C₂ tuning.

FIG. 9 depicts a plot of voltage versus time representing a transient response of the clock distribution network of FIG. 4 with an operational frequency of 10 GHz, in accordance with various embodiments. The plot demonstrates that the transient response has low distortion.

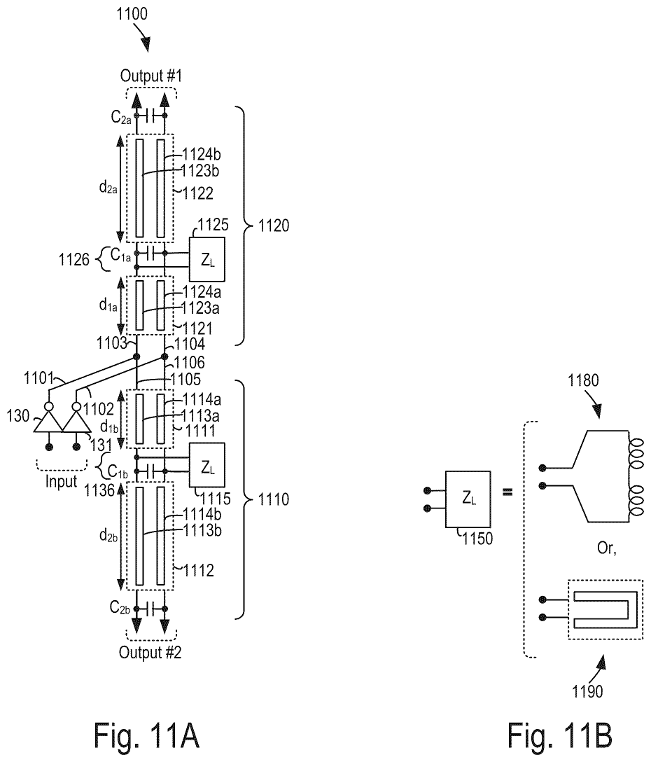

FIG. 10 depicts a plot of voltage versus time representing a transient response of the clock distribution network of FIG. 4 with an operational frequency of 16 GHz, in accordance with various embodiments. The plot demonstrates that the transient response has low distortion.

FIGS. 9 and 10 also show that distortion is reduced across the tuning range, taking 10 GHz and 16 GHz, respectively, as examples. Note that along with the inductor area improvement, the designs also maintain the energy efficiency and jitter filtering benefits of a resonant TL.

FIGS. 6-10 are from a post-layout simulation of the clock distribution network.

FIG. 11A depicts an example two-sided clock distribution network 1100 consistent with FIGS. 4 and 5, in accordance with various embodiments. The network includes a first TL 1110 and a second TL 1120.

The first TL 1110 includes a first portion 1121 with first and second signal line portions 1123a and 1124a, respectively, and with a length d₁ₐ, an intermediate portion 1126 with first and second signal line portions, and a second portion 1122 with first and second signal line portions 1123b and 1124b, respectively, and with a length d₂ₐ. At the input end of the first TL, input paths 1103 and 1104 are coupled to clock input paths 1101 and 1102, respectively, of clocks 130 and 131, respectively. A capacitance C₁ₐ between the first and second portions 1121 and 1122, respectively, may represent two capacitors in series such as depicted by the capacitors 2C1 in FIGS. 4 and 5. A capacitance C₂ₐ at the output of the TL 1120 (output #1) may represent two capacitors in series such as depicted by the capacitors 2C2 in FIGS. 4 and 5. The impedance block 1125 (having an impedance Z_{L}) can represent, e.g., the inductors 421 and 422 of FIG. 4 or the coiled inductors 1180 of FIG. 11B, or the short-circuited transmission line 540 or 1190 of FIG. 5 or FIG. 11B, respectively.

The second TL 1120 includes a first portion 1111 with first and second signal line portions 1113a and 1114a, respectively, and with a length dib, an intermediate portion 1136 with first and second signal line portions, and a second portion 1112 with first and second signal line portions 1113b and 1114b, respectively, and with a length d₂ₐ. At the input end of the second TL, input paths 1105 and 1106 are coupled to clock input paths 1101 and 1102, respectively, of clocks 130 and 131, respectively. A capacitance C_{1b} between the first and second portions 1111 and 1112, respectively, may represent two capacitors in series such as depicted by the capacitors 2C₁ in FIGS. 4 and 5. A capacitance C_{2b} at the output of the TL 1110 (output #2) may represent two capacitors in series such as depicted by the capacitors 2C₂ in FIGS. 4 and 5. The impedance block 1115 can be similar to the impedance block 1125.

The distances d₁ₐ and d_{1b} can be the same or different and the distances d₂ₐ and d_{2b} can be the same or different.

FIG. 11B depicts example implementations of an impedance block 1150 consistent with FIG. 11A as one or more coiled inductors 1180 or as an inductive short-circuited transmission line 1190, in accordance with various embodiments. The impedance block 1150 can represent the impedance blocks 1115 and 1125 of FIG. 11A, for example. As mentioned, the impedance block can include one or more coiled inductors 1180 or a short-circuited transmission line 1190. In theory, both could be used as well.

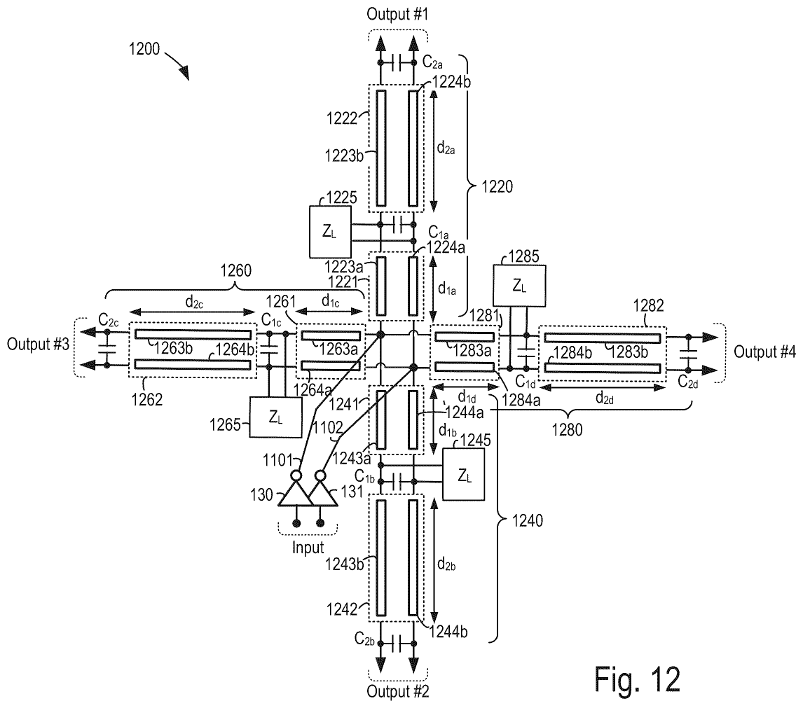

FIG. 12 depicts an example four-sided clock distribution network 1200 consistent with FIGS. 4 and 5, in accordance with various embodiments. The network includes a first TL 1220, a second TL 1240, a third TL 1260 and a fourth TL 1280.

The first TL 1220 includes a first portion 1221 with first and second signal line portions 1223a and 1224a, respectively, and with a length d₁ₐ, an intermediate portion with first and second signal line portions, and a second portion 1222 with first and second signal line portions 1223b and 1224b, respectively, and with a length d₂ₐ. The output of the TL is at output #1. At the input end of the first TL, input paths are coupled to clock input paths 1101 and 1102 of clocks 130 and 131, respectively. The capacitances C₁ₐ and C₂ₐ and the impedance block 1225 can be provided as discussed.

The second TL 1240 includes a first portion 1241 with first and second signal line portions 1243a and 1244a, respectively, and with a length dib, an intermediate portion with first and second signal line portions, and a second portion 1242 with first and second signal line portions 1243b and 1244b, respectively, and with a length d_{2b}. The output of the TL is at output #2. At the input end of the second TL, input paths are coupled to clock input paths 1101 and 1102 of clocks 130 and 131, respectively. The capacitances C_{1b} and C_{2b} and the impedance block 1245 can be provided as discussed.

The third TL 1260 includes a first portion 1261 with first and second signal line portions 1263a and 1264a, respectively, and with a length d_{1c}, an intermediate portion with first and second signal line portions, and a second portion 1262 with first and second signal line portions 1263b and 1264b, respectively, and with a length d_{2c}. The output of the TL is at output #3. At the input end of the third TL, input paths are coupled to clock input paths 1101 and 1102 of clocks 130 and 131, respectively. The capacitances C_{1c} and C_{2c} and the impedance block 1265 can be provided similarly as discussed.

The fourth TL 1280 includes a first portion 1281 with first and second signal line portions 1283a and 1284a, respectively, and with a length did, an intermediate portion with first and second signal line portions, and a second portion 1282 with first and second signal line portions 1283b and 1284b, respectively, and with a length d_{2d}. The output of the TL is at output #4. At the input end of the fourth TL, input paths are coupled to clock input paths 1101 and 1102 of clocks 130 and 131, respectively. The capacitances C_{1d} and C_{2d} and the impedance block 1285 can be provided similarly as discussed.

The distances d₁ₐ, d_{1b}, d_{1c} and d₁ₐ can be the same or different and the distances d₂ₐ, d_{2b}, d_{2c} and d₂ₐ can be the same or different.

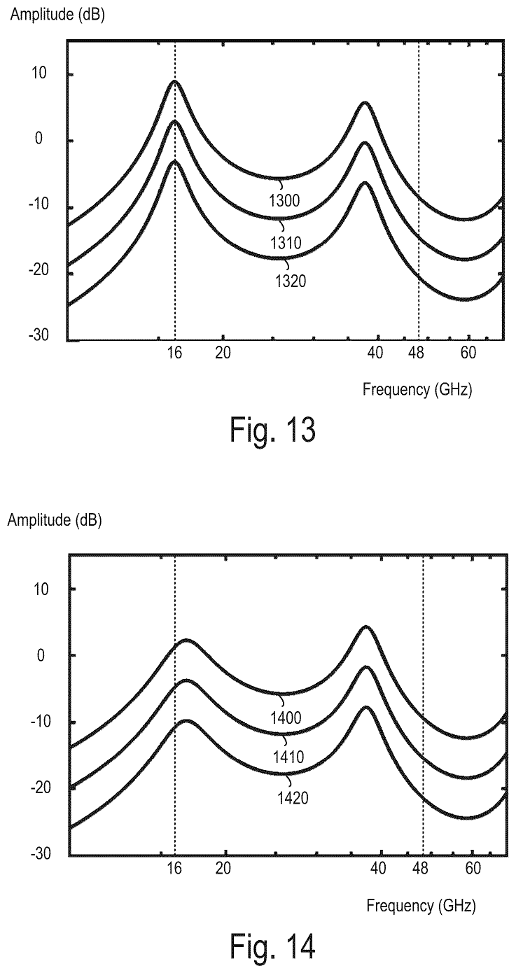

While one-, two- and four-sided clock distribution networks have been depicted, generally, one or more sides can be used. The area efficient resonant TL-based clock distribution architectures in FIGS. 4 and 5 can therefore be generalized for distributing clock signals symmetrically from a single feed point towards multiple destination nodes. In one approach, the network includes multiple identical branches which receive the common clock signals from a single set of drivers and a single feed point. These architectures can be directly applicable to distribute the clock from a source node (e.g., of a PLL or a forwarded clock) to various parts of a chip in wireline, optical or wireless transceivers. FIGS. 13 and 14 show that as the number of distribution branches/sides increases, the frequency response of these multi-destination-node architectures stays relatively similar, with approximately 6 dB of gain drop for every doubling of the number of branches.

FIG. 13 depicts plots of amplitude in decibels (dB) versus frequency in GHz for a one-sided distribution consistent with FIG. 4 (plot 1300), a two-sided distribution consistent with FIG. 11A (plot 1310), and a four-sided distribution consistent with FIG. 12 (plot 1320), where the inductance of the LC termination is provided by the coiled inductors 1180 of FIG. 11B, in accordance with various embodiments. With a desired primary resonance of, e.g., 16 GHz, the third harmonic is at 48 GHz, as shown by the vertical dotted lines. The amplitude peaks are aligned for each plot at 16 GHz. In an example design, d₂≈2_{d1}=1 mm, C₁≈4C₂=75 fF and L=400 pH (Q=13). The quality factor (or Q) of an inductor is the ratio of its inductive reactance to its resistance at a given frequency, and is a measure of its efficiency. The higher the Q factor of the inductor, the closer it approaches the behavior of an ideal inductor.

FIG. 14 depicts plots of amplitude in decibels (dB) versus frequency in GHz for a one-sided distribution consistent with FIG. 5 (plot 1400), a two-sided distribution consistent with FIG. 11A (plot 1410), and a four-sided distribution consistent with FIG. 12 (plot 1420), where the inductance of the LC termination is provided by the inductive short-circuited transmission line 1190 of FIG. 11B, in accordance with various embodiments. The example primary resonance of 16 GHz and the third harmonic at 48 GHz are shown by the vertical dotted lines. In an example design, d₂≈2d₁=1 mm, d3=0.5 mm, C1≈4C2=75 fF and L=400 pH (Q=13).

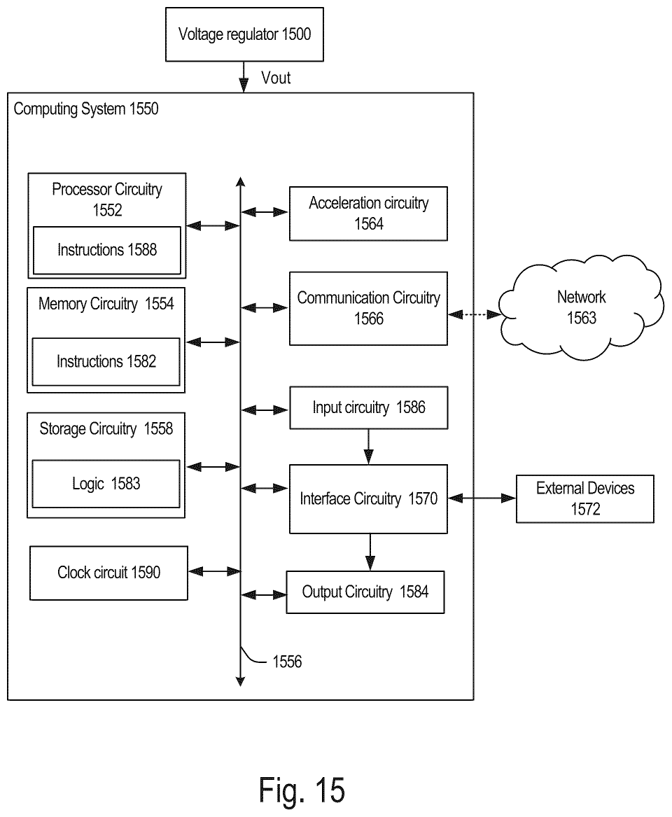

FIG. 15 illustrates an example of components that may be present in a computing system 1550 for implementing the techniques (e.g., operations, processes, methods, and methodologies) described herein. A clock circuit 1590 may include the clock distribution networks discussed herein, including those depicted in FIGS. 4, 5, 11A, 11B and 12.

The computing system 1550 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1550, or as components otherwise incorporated within a chassis of a larger system. For one embodiment, at least one processor 1552 may be packaged together with computational logic 1582 and configured to practice aspects of various example embodiments described herein to form a System in Package (SiP) or a System on Chip (SoC).

The voltage regulator 1500 may provide a voltage Vout to one or more of the components of the computing system 1550. The memory circuitry 1554 may store instructions and the processor circuitry 1552 may execute the instructions to perform the functions described herein.

The system 1550 includes processor circuitry in the form of one or more processors 1552. The processor circuitry 1552 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1552 may include one or more hardware accelerators (e.g., same or similar to acceleration circuitry 1564), which may be microprocessors, programmable processing devices (e.g., FPGA, ASIC, etc.), or the like. The one or more accelerators may include, for example, computer vision and/or deep learning accelerators. In some implementations, the processor circuitry 1552 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1552 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1552 may be coupled with or may include memory/storage and may be configured to execute instructions stored in the memory/storage to enable various applications or operating systems to run on the platform 1550. The processors (or cores) 1752 is configured to operate application software to provide a specific service to a user of the platform 1750. In some embodiments, the processor(s) 1752 may be a special-purpose processor(s)/controller(s) configured (or configurable) to operate according to the various embodiments herein.

As examples, the processor(s) 1552 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1552 may be a part of a system on a chip (SoC), System-in-Package (SiP), a multi-chip package (MCP), and/or the like, in which the processor(s) 1552 and other components are formed into a single integrated circuit, or a single package, such as the Edison™ or Galileo™ SoC boards from Intel® Corporation. Other examples of the processor(s) 1552 are mentioned elsewhere in the present disclosure.

The system 1550 may include or be coupled to acceleration circuitry 1564, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1564 may comprise logic blocks or logic fabric and other interconnected resources that may be programmed (configured) to perform various functions, such as the procedures, methods, functions, etc. of the various embodiments discussed herein. In such implementations, the acceleration circuitry 1564 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1552 and/or acceleration circuitry 1564 may include hardware elements specifically tailored for machine learning and/or artificial intelligence (AI) functionality. In these implementations, the processor circuitry 1552 and/or acceleration circuitry 1764 may be, or may include, an AI engine chip that can run many different kinds of AI instruction sets once loaded with the appropriate weightings and training code. Additionally or alternatively, the processor circuitry 1552 and/or acceleration circuitry 1564 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1552 and/or acceleration circuitry 1764 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 1550 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1550 also includes system memory 1554. Any number of memory devices may be used to provide for a given amount of system memory. As examples, the memory 1554 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1554 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1554 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1558 provides persistent storage of information such as data, applications, operating systems and so forth. In an example, the storage 1558 may be implemented via a solid-state disk drive (SSDD) and/or high-speed electrically erasable memory (commonly referred to as “flash memory”). Other devices that may be used for the storage 1558 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1554 and/or storage circuitry 1558 may also incorporate three-dimensional (3D) cross-point (XPOINT) memories from Intel® and Micron®.

The memory circuitry 1554 and/or storage circuitry 1558 is/are configured to store computational logic 1583 in the form of software, firmware, microcode, or hardware-level instructions to implement the techniques described herein. The computational logic 1583 may be employed to store working copies and/or permanent copies of programming instructions, or data to create the programming instructions, for the operation of various components of system 1550 (e.g., drivers, libraries, application programming interfaces (APIs), etc.), an operating system of system 1550, one or more applications, and/or for carrying out the embodiments discussed herein. The computational logic 1583 may be stored or loaded into memory circuitry 1554 as instructions 1582, or data to create the instructions 1582, which are then accessed for execution by the processor circuitry 1552 to carry out the functions described herein. The processor circuitry 1552 and/or the acceleration circuitry 1564 accesses the memory circuitry 1554 and/or the storage circuitry 1558 over the interconnect (IX) 1556. The instructions 1582 direct the processor circuitry 1552 to perform a specific sequence or flow of actions, for example, as described with respect to flowchart(s) and block diagram(s) of operations and functionality depicted previously. The various elements may be implemented by assembler instructions supported by processor circuitry 1552 or high-level languages that may be compiled into instructions 1588, or data to create the instructions 1588, to be executed by the processor circuitry 1552. The permanent copy of the programming instructions may be placed into persistent storage devices of storage circuitry 1558 in the factory or in the field through, for example, a distribution medium (not shown), through a communication interface (e.g., from a distribution server (not shown)), over-the-air (OTA), or any combination thereof.

The IX 1556 couples the processor 1552 to communication circuitry 1566 for communications with other devices, such as a remote server (not shown) and the like. The communication circuitry 1566 is a hardware element, or collection of hardware elements, used to communicate over one or more networks 1563 and/or with other devices. In one example, communication circuitry 1566 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1566 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1556 also couples the processor 1552 to interface circuitry 1570 that is used to connect system 1550 with one or more external devices 1572. The external devices 1572 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1550, which are referred to as input circuitry 1586 and output circuitry 1584. The input circuitry 1586 and output circuitry 1584 include one or more user interfaces designed to enable user interaction with the platform 1550 and/or peripheral component interfaces designed to enable peripheral component interaction with the platform 1550. Input circuitry 1586 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1584 may be included to show information or otherwise convey information, such as sensor readings, actuator position(s), or other like information. Data and/or graphics may be displayed on one or more user interface components of the output circuitry 1584. Output circuitry 1584 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1550. The output circuitry 1584 may also include speakers and/or other audio emitting devices, printer(s), and/or the like. Additionally or alternatively, sensor(s) may be used as the input circuitry 1584 (e.g., an image capture device, motion capture device, or the like) and one or more actuators may be used as the output device circuitry 1584 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1550 may communicate over the IX 1556. The IX 1556 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1556 may be a proprietary bus, for example, used in a SoC based system.

The number, capability, and/or capacity of the elements of system 1550 may vary, depending on whether computing system 1550 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1550 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Some non-limiting examples of various embodiments are presented below.

Example 1 includes an apparatus, comprising: a transmission line comprising first and second signal lines, wherein the first and second signal lines are arranged in first and second portions of the transmission line, the first portion is coupled to an input of the transmission line, and the second portion is coupled to an output of the transmission line; an inductive-capacitive termination coupled to the first and second signal lines between the first and second portions; and a capacitive termination coupled to the first and second signal lines at the output of the transmission line.

Example 2 includes the apparatus of Example 1, wherein: the inductive-capacitive termination comprises one or more capacitors coupled in series between the first and second signal lines, and one or more inductors coupled in series between the first and second signal lines; and the one or more capacitors are in parallel with the one or more inductors.

Example 3 includes the apparatus of Example 2, wherein the one or more capacitors care tunable.

Example 4 includes the apparatus of any one of Examples 1-3, wherein the capacitive termination comprises one or more capacitors coupled in series between the first and second signal lines.

Example 5 includes the apparatus of any one of Examples 1-4, wherein a length of the second portion is greater than a length of the first portion.

Example 6 includes the apparatus of any one of Examples 1-5, wherein a length of the second portion is approximately equal to twice a length of the first portion, within a margin of +/−10%.

Example 7 includes the apparatus of any one of Examples 1 and 3-6, wherein the inductive-capacitive termination comprises a short-circuited transmission line, and the short-circuited transmission line comprises parallel conductive paths.

Example 8 includes the apparatus of Example 7, wherein a length of the first portion is approximately equal to a length of the short-circuited transmission line, within a margin of +/−10%.

Example 9 includes the apparatus of any one of Examples 1-8, wherein the capacitive termination comprises one or more tunable capacitors coupled in series between the first and second signal lines.

Example 10 includes the apparatus of any one of Examples 1-9, further comprising first and second clock drivers coupled to the first and second signal lines, respectively, at the input of the transmission line, wherein the first clock driver is to output a first clock signal on the first signal line and the second clock driver is to output a second clock signal, which is an inverse of the first clock signal, on the second signal line.

Example 11 includes the apparatus of any one of Examples 1-10, further comprising at least one of an integrated circuit, a System on Chip, a System in Package or a computing device in which the transmission line, the inductive-capacitive termination and the capacitive termination are provided in a clock distribution network, wherein the clock distribution network is for at least one of an optical, wireline or wireless system.

Example 12 includes a clock distribution network, comprising: a clock source; a plurality of transmission lines, wherein each transmission line of the plurality of transmission lines comprises an input end coupled to the clock source; and for each transmission line of the plurality of transmission lines, an inductive-capacitive termination coupled to the transmission line partway along a length of the transmission line, and a capacitive termination at an output end of the transmission line.

Example 13 includes the clock distribution network of Example 12, wherein: each transmission line of the plurality of transmission lines comprises first and second signal lines; and for at least one transmission line of the plurality of transmission lines: the inductive-capacitive termination comprises one or more capacitors coupled in series between the first and second signal lines, and one or more inductors coupled in series between the first and second signal lines; and the one or more capacitors are in parallel with the one or more inductors.

Example 14 includes the clock distribution network of Example 12, wherein: each transmission line of the plurality of transmission lines comprises first and second signal lines; and for at least one transmission line of the plurality of transmission lines: the inductive-capacitive termination comprises one or more capacitors coupled in series between the first and second signal lines and a short-circuited transmission line, wherein the short-circuited transmission line comprises a first conductor coupled to the first signal line, a second conductor coupled to the second signal line and parallel to the first conductor, and a path coupling the first conductor to the second conductor.

Example 15 includes the clock distribution network of any one of Examples 12-14, wherein: each transmission line of the plurality of transmission lines comprises first and second signal lines; and for at least one transmission line of the plurality of transmission lines, the capacitive termination comprises one or more tunable capacitors coupled in series between the first and second signal lines.

Example 16 includes the clock distribution network of any one of Examples 12-15, wherein for at least one transmission line of the plurality of transmission lines: the inductive-capacitive termination is coupled to the transmission line at a first distance along the transmission line from the input end and a second distance along the transmission line from the output end; and the second distance is greater than the first distance.

Example 17 includes an apparatus, comprising: a transmission line having an input end coupled to a clock source; an inductive-capacitive termination coupled to the transmission line at a tap point which is a first distance along the transmission line from the input end and a second distance along the transmission line from an output end of the transmission line, wherein the second distance is greater than the first distance; and a capacitive termination at an output end of the transmission line.

Example 18 includes the apparatus of Example 17, wherein the second distance is approximately equal to twice the first distance, within a margin of +/−10%.

Example 19 includes the apparatus of Example 17 or 18, wherein the inductive-capacitive termination is tunable to tune a first harmonic of a signal on the transmission line.

Example 20 includes the apparatus of any one of Examples 17-19, wherein the capacitive termination is tunable to tune a third harmonic of a signal on the transmission line.

Example 21 includes a method, comprising: inputting clock signals to an input of transmission line; and outputting clock signals from an output of the transmission line, wherein: the transmission line comprises first and second signal lines; the first and second signal lines are arranged in first and second portions of the transmission line; the first portion is coupled to the input of the transmission line; the second portion is coupled to the output of the transmission line; an inductive-capacitive termination is coupled to the first and second signal lines between the first and second portions; and a capacitive termination is coupled to the first and second signal lines at the output of the transmission line.

Example 22 includes a non-transitory machine-readable storage including machine-readable instructions that, when executed, cause a processor or other circuit or computing device to implement the method of Example 21.

Example 23 includes a computer program comprising instructions which, when the program is executed by a computer, cause the computer to carry out the method of Example 21.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a transmission line comprising first and second signal lines, wherein the first and second signal lines are arranged in first and second portions of the transmission line, the first portion is coupled to an input of the transmission line, and the second portion is coupled to an output of the transmission line;
an inductive-capacitive termination coupled to the first and second signal lines between the first and second portions; and
a capacitive termination coupled to the first and second signal lines at the output of the transmission line.

2. The apparatus of claim 1, wherein the inductive-capacitive termination comprises one or more capacitors coupled in series between the first and second signal lines, and one or more inductors coupled in series between the first and second signal lines.

3. The apparatus of claim 2, wherein the one or more capacitors are in parallel with the one or more inductors.

4. The apparatus of claim 2, wherein the one or more capacitors are tunable.

5. The apparatus of claim 1, wherein a length of the second portion is greater than a length of the first portion.

6. The apparatus of claim 1, wherein the inductive-capacitive termination comprises a short-circuited transmission line, and the short-circuited transmission line comprises parallel conductive paths.

7. The apparatus of claim 1, wherein the capacitive termination comprises one or more capacitors coupled in series between the first and second signal lines.

8. The apparatus of claim 7, wherein the one or more capacitors are tunable.

9. The apparatus of claim 1, further comprising first and second clock drivers coupled to the first and second signal lines, respectively, at the input of the transmission line, wherein the first clock driver is to output a first clock signal on the first signal line and the second clock driver is to output a second clock signal, which is an inverse of the first clock signal, on the second signal line.

10. The apparatus of claim 1, further comprising at least one of an integrated circuit, a System on Chip, a System in Package or a computing device in which the transmission line, the inductive-capacitive termination and the capacitive termination are provided in a clock distribution network, wherein the clock distribution network is for at least one of an optical, wireline or wireless system.

11. A clock distribution network, comprising:
a clock source;
a plurality of transmission lines, wherein each transmission line of the plurality of transmission lines comprises an input end coupled to the clock source; and
for each transmission line of the plurality of transmission lines, an inductive-capacitive termination coupled to the transmission line partway along a length of the transmission line, and a capacitive termination at an output end of the transmission line.

12. The clock distribution network of claim 11, wherein:
each transmission line of the plurality of transmission lines comprises first and second signal lines; and
for at least one transmission line of the plurality of transmission lines:
the inductive-capacitive termination comprises one or more capacitors coupled in series between the first and second signal lines, and one or more inductors coupled in series between the first and second signal lines.

13. The clock distribution network of claim 12, wherein the one or more capacitors are in parallel with the one or more inductors.

14. The clock distribution network of claim 11, wherein:
each transmission line of the plurality of transmission lines comprises first and second signal lines; and
for at least one transmission line of the plurality of transmission lines:
the inductive-capacitive termination comprises one or more capacitors coupled in series between the first and second signal lines and a short-circuited transmission line, wherein the short-circuited transmission line comprises a first conductor coupled to the first signal line, a second conductor coupled to the second signal line and parallel to the first conductor, and a path coupling the first conductor to the second conductor.

15. The clock distribution network of claim 11, wherein:
each transmission line of the plurality of transmission lines comprises first and second signal lines; and
for at least one transmission line of the plurality of transmission lines, the capacitive termination comprises one or more tunable capacitors coupled in series between the first and second signal lines.

16. The clock distribution network of claim 11, wherein for at least one transmission line of the plurality of transmission lines:
the inductive-capacitive termination is coupled to the transmission line at a first distance along the transmission line from the input end and a second distance along the transmission line from the output end.

17. The clock distribution network of claim 16, wherein the second distance is greater than the first distance.

18. An apparatus, comprising:
a transmission line having an input end coupled to a clock source;
an inductive-capacitive termination coupled to the transmission line at a tap point which is a first distance along the transmission line from the input end and a second distance along the transmission line from an output end of the transmission line, wherein the second distance is greater than the first distance; and
a capacitive termination at an output end of the transmission line.

19. The apparatus of claim 18, wherein the inductive-capacitive termination is tunable to tune a first harmonic of a signal on the transmission line.

20. The apparatus of claim 18, wherein the capacitive termination is tunable to tune a third harmonic of a signal on the transmission line.
